(19) United States
(12) Patent Application Publication
(10) Pub. No.: US 2026/0065455 A1
(43) Pub. Date: Mar. 5, 2026

(54) APPARATUS AND METHOD FOR EVALUATING RELIABILITY OF HUMAN POSE ESTIMATION ALGORITHM

(71) Applicant: Electronics and Telecommunications Research Institute, Daejeon (KR)

(72) Inventors: Hwi Gang KIM, Daejeon (KR); Sang Beom LEE, Daejeon (KR); Kwang Yong KIM, Daejeon (KR)

(73) Assignee: Electronics and Telecommunications Research Institute, Daejeon (KR)

(21) Appl. No.: 19/315,968

(22) Filed: Sep. 2, 2025

(30) Foreign Application Priority Data
Sep. 2, 2024 (KR) 10-2024-0118818

(51) Int. Cl. G06T 7/00; G06T 7/73

(52) U.S. Cl. CPC G06T 7/0002; G06T 7/74; G06T 2207/30196

(57) ABSTRACT

According to the present invention, an apparatus for evaluating reliability of a human pose estimation algorithm for estimating a human three-dimensional (3D) pose based on a monocular image includes a memory configured to store at least one instruction; and a processor configured to execute the at least one instruction stored in the memory, in which the processor acquires a first image obtained by capturing an image of a person rotating in a preset specific pose with a single camera, performs a process of estimating first body information of the person from the first image using a target human pose estimation algorithm for each frame, and evaluates reliability of the target human pose estimation algorithm based on the first body information estimated for each frame.

### CROSS-REFERENCE TO RELATED APPLICATION

This application claims priority to and the benefit of Korean Patent Application No. 10-2024-0118818, filed on Sep. 2, 2024, the disclosure of which is incorporated herein by reference in its entirety.

### BACKGROUND

1 Field of the Invention

The present invention relates to an apparatus and method for evaluating reliability of a human pose estimation algorithm, and more particularly, to an apparatus and method for evaluating reliability of a three-dimensional (3D) pose estimation algorithm based on a monocular image.

### 2. DISCUSSION OF RELATED ART

With the recent advancements in artificial intelligence and deep learning technologies, the development of three-dimensional (3D) pose estimation techniques has been actively progressing. These vision-based 3D pose estimation technologies and various services utilizing them do not require attaching separate sensors to the body to estimate a user's pose, and do not impose behavioral constraints, such as requiring a user to touch equipment or other sensors, and are being utilized in various forms across multiple fields, including indoor sports, home training, and posture correction.

Meanwhile, the performance of an application utilizing a 3D pose estimation model is determined by the performance of the 3D pose estimation model used in the application. Accordingly, a developer of such an application needs to evaluate the performance of each developed 3D pose estimation model and determine the 3D pose estimation model suitable for the application by referring to the evaluation results. However, due to the differences between the environment in which the performance of the 3D pose estimation model is evaluated and the environment in which the 3D pose estimation model was trained as well as the absence of ground truth for keypoints, it is not easy to evaluate the performance of the 3D pose estimation model. Therefore, there is a need for a technology capable of easily evaluating the performance of the 3D pose estimation model.

### SUMMARY OF THE INVENTION

The present invention is directed to providing an apparatus and method for evaluating reliability of a human pose estimation algorithm capable of estimating a human three-dimensional (3D) pose based on a monocular image without requiring separate ground truth.

According to an aspect of the present invention, there is provided an apparatus for evaluating reliability of a human pose estimation algorithm for estimating a human 3D pose based on a monocular image, which includes: a memory configured to store at least one instruction; and a processor configured to execute the at least one instruction stored in the memory, in which the processor acquires a first image obtained by capturing an image of a person rotating in a preset specific pose with a single camera, performs a process of estimating first body information of the person from the first image using a target human pose estimation algorithm for each frame, and evaluates reliability of the target human pose estimation algorithm based on the first body information estimated for each frame.

The first body information may include a length or angle of a preset specific body part.

When evaluating the reliability of the target human pose estimation algorithm based on the first body information estimated for each frame, the processor may calculate a first indicator indicating consistency of the first body information estimated for each frame.

The first indicator may be calculated from the following Equation 1.

$$Consistency ( x ) = \frac{{\sum }_{i = 1}^{N} \vert {x}_{i} - σ \vert}{{α}_{scale} \times N} , where σ = \frac{M + m}{2} \qquad [ Equation 1 ]$$

(Here, consistency is the first indicator, xᵢ is human body information estimated from an ith frame, α_{scale} is a scaling factor, N is a total number of frames, M is a maximum value of the human body information estimated for each frame, and m is a minimum value of the human body information estimated for each frame).

The processor may acquire a second image obtained by capturing an image of a person rotating while repeating a preset specific motion at a preset cycle with the single camera, perform a process of estimating second body information of the person from the second image using the target human pose estimation algorithm for each frame, and evaluate the reliability of the target human pose estimation algorithm based on the second body information estimated for each frame.

The specific motion may be repeated two or more times while the person rotates 360°.

The second body information may include an angle of a preset specific body part.

When evaluating the reliability of the target human pose estimation algorithm based on the second body information estimated for each frame, the processor may divide the second body information estimated for each frame into multiple groups and calculate a second indicator indicating similarity of change patterns of the second body information for each group.

The processor may divide the second body information estimated for each frame according to the preset cycle.

According to another aspect of the present invention, there is provided an apparatus for evaluating reliability of a human pose estimation algorithm for estimating a human 3D pose based on a monocular image, which includes: a memory configured to store at least one instruction; and a processor configured to execute the at least one instruction stored in the memory, in which the processor acquires an image obtained by capturing an image of a person rotating while repeating a preset specific motion at a preset cycle with a single camera, performs a process of estimating the human body information from the image using the target human pose estimation algorithm for each frame, and evaluates the reliability of the target human pose estimation algorithm based on the body information estimated for each frame.

According to still another aspect of the present invention, there is provided a method of evaluating reliability of a human pose estimation algorithm for estimating a human 3D pose based on a monocular image, which is performed on a computing device including a processor, including: acquiring a first image obtained by capturing an image of a person rotating in a preset specific pose with a single camera; performing a process of estimating first body information of the person from the first image using a target human pose estimation algorithm for each frame; and evaluating reliability of the target human pose estimation algorithm based on the first body information estimated for each frame.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for evaluating reliability of a human pose estimation algorithm according to an embodiment of the present invention;

FIG. 2 is an exemplary diagram illustrating a preset specific pose;

FIGS. 3A and 3B are exemplary diagrams illustrating first body information estimated for each frame;

FIG. 4 is an exemplary diagram for describing a preset specific motion;

FIGS. 5A and 5B are exemplary diagrams for describing second body information estimated for each frame;

FIG. 6 is a first flowchart illustrating a method of evaluating reliability of a human pose estimation algorithm according to an embodiment of the present invention; and

FIG. 7 is a second flowchart illustrating the method of evaluating reliability of a human pose estimation algorithm according to an embodiment of the present invention.

### DETAILED DESCRIPTION OF EXEMPLARY EMBODIMENTS

Hereinafter, an embodiment of an apparatus and method for evaluating reliability of a human pose estimation algorithm according to the present invention will be described with reference to the accompanying drawings. In this process, thicknesses of lines, sizes of components, and the like illustrated in the accompanying drawings may be exaggerated for clearness of explanation and convenience. In addition, terms to be described below are defined in consideration of functions in the present disclosure and may be construed in different ways according to the intention of users or practice. Therefore, these terms should be defined on the basis of the content throughout the present specification.

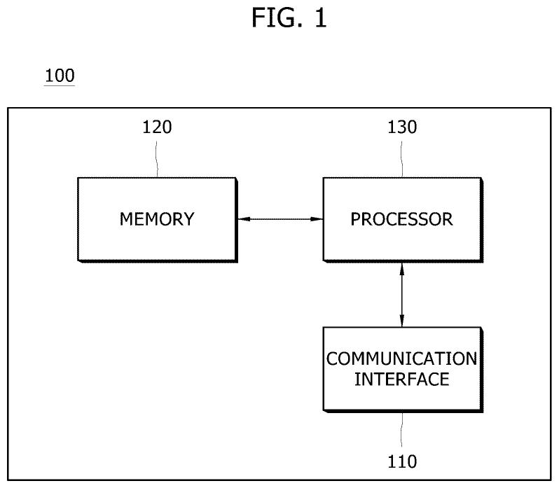

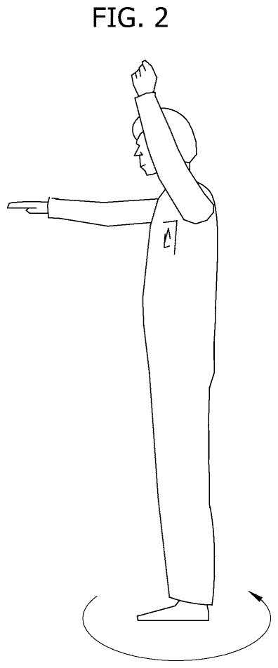

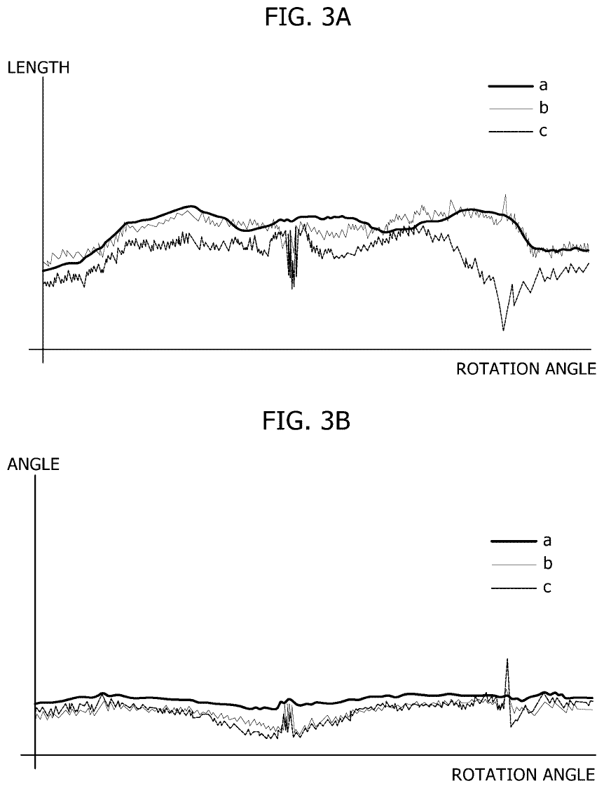

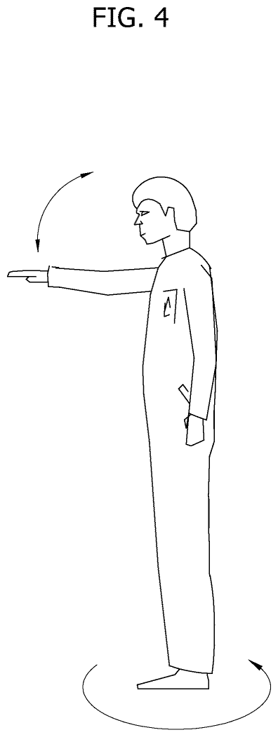

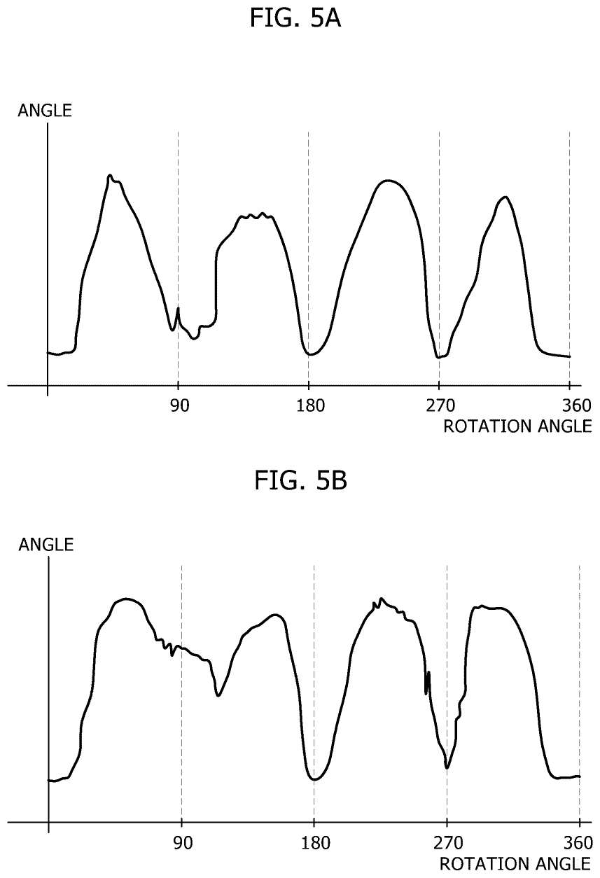

FIG. 1 is a block diagram illustrating an apparatus for evaluating reliability of a human pose estimation algorithm according to an embodiment of the present invention, FIG. 2 is an exemplary diagram illustrating a preset specific pose, FIGS. 3A and 3B are exemplary diagrams illustrating first body information estimated for each frame, FIG. 4 is an exemplary diagram for describing a preset specific motion, and FIGS. 5A and 5B are exemplary diagrams for describing second body information estimated for each frame.

Referring to FIG. 1, an apparatus 100 for evaluating reliability of a human pose estimation algorithm according to an embodiment of the present invention may include a communication interface 110, a memory 120, and a processor 130. In addition to the components illustrated in FIG. 1, the apparatus 100 for evaluating reliability of a human pose estimation algorithm according to an embodiment of the present invention may include various additional components or may not include some of the above components.

The communication interface 110 may communicate with an external device. The communication interface 110 may communicate with various types of external devices depending on various types of communication manners.

The memory 120 may store at least one command executed by the processor 130. The memory 120 may be implemented as a volatile storage medium and/or a non-volatile storage medium, and may be implemented as, for example, a read only memory (ROM) and/or a random access memory (RAM). The memory 120 may store various types of information required during the operation of the processor 130. The memory 120 may store various types of information calculated during the operation of the processor 130.

The processor 130 may be operatively connected to the communication interface 110 and the memory 120. The processor 130 may be implemented as a central processing unit (CPU) or a system on chip (SoC) and control multiple hardware or software components connected to the processor 130 by running an operating system or application and perform various data processing and calculations. The processor 130 may be configured to execute at least one command stored in the memory 120 and store the execution result data in the memory 120.

The processor 130 may acquire an image (hereinafter, “first image”) obtained by capturing an image of a person rotating in a preset specific pose with a single camera, estimate human body information (hereinafter, “first body information”) from the first image using a target human pose estimation algorithm for each frame (rotation angle), and evaluate the reliability of the target human pose estimation algorithm based on the first body information estimated for each frame.

As illustrated in FIG. 2, the preset specific pose may be a pose in which one arm is straightened upward and the other arm is straightened forward but is not limited thereto. Various poses in which a length or angle of a specific body part of a person may be easily confirmed may be used as a specific pose.

Rotation of a person may be performed by the corresponding person or by a rotation device such as a turntable. In various embodiments, instead of rotating the person during the capturing of the first image, a camera may be moved along a circumference of a circle centered on the person. Meanwhile, a mannequin may be used instead of a person.

The target human pose estimation algorithm is a human pose estimation algorithm whose reliability is to be evaluated and may be a human pose estimation algorithm that estimates a three-dimensional (3D) pose of a person based on a monocular image. The human pose estimation algorithm may detect a position, length, and angle of a specific body part from the monocular image. Various well-known human pose estimation algorithms or newly developed human pose estimation algorithms may be selected as the target human pose estimation algorithm.

The first body information may include information on the length or angle of the preset specific body part. The preset specific body part may be a body part whose length may be confirmed from a captured image of a person, such as an upper arm, forearm, calf, or thigh of a person. The preset specific body part may also be a joint part whose angle may be confirmed from a captured image of a person, such as an armpit, an elbow, or a knee.

The human body does not lengthen or shorten due to rotation. Therefore, when a person rotates while maintaining a specific pose, a length of a human body remains constant regardless of the rotation angle. Therefore, the length of the human body estimated by the human pose estimation algorithm should also remain constant regardless of the rotation angle (capturing direction). Furthermore, when a person rotates while maintaining a specific pose, the angle of the human body remains constant regardless of the rotation angle. Therefore, the angle of the human body estimated by the human pose estimation algorithm should also remain constant regardless of the rotation angle (capturing direction). According to the present embodiment, by confirming whether a length or angle of a specific body part estimated for each frame of an image obtained by capturing an image of a person rotating 360° in a specific pose remains constant, it is possible to evaluate the reliability of the human pose estimation algorithm used for the corresponding estimation.

When evaluating the reliability of the target human pose estimation algorithm based on the first body information estimated for each frame, the processor 130 may calculate a first indicator indicating the consistency of the first body information estimated for each frame. The first indicator is a cumulative sum of changes in the first body information that occur while the person rotates and may be an indicator indicating how consistent the first body information estimated for each frame by the target human pose estimation algorithm remains. A large first indicator may indicate low reliability of the corresponding human pose estimation algorithm. The first indicator may be calculated from the following Equation 1.

$$Consistency ( x ) = \frac{{\sum }_{i = 1}^{N} \vert {x}_{i} - σ \vert}{{α}_{scale} \times N} , \qquad [ Equation 1 ]$$

$$where σ = \frac{M + m}{2}$$

Here, consistency may be the first indicator, xᵢ may be human body information estimated from an ith frame, α_{scale} may be a preset value of a scaling factor, N may be the total number of frames (the total number of frames included in the image captured while a person rotates 360°), M may be a maximum value of the human body information estimated for each frame, and m may be a minimum value of the human body information estimated for each frame. The method of calculating the first indicator is not limited to the above Equation 1, and various equations that may confirm the changes in the first body information that occur while the person rotates may be employed to calculate the first indicator.

For example, the processor 130 acquires the image of the person rotating 360° with one arm straightened upward and the other arm straightened forward, and performs an operation of estimating the length of the upper arm from the acquired image for each frame from each of human pose estimation algorithms a, b, and c, thereby obtaining a graph as illustrated in FIG. 3A. In FIG. 3A, the human pose estimation algorithm with the smallest change in the length of the upper arm depending on the rotation angle is the human pose estimation algorithm a, and thus the human pose estimation algorithm with the highest reliability is the human pose estimation algorithm a.

As another example, the processor 130 acquires the image of the person rotating 360° with one arm straightened upward and the other arm straightened forward, and performs an operation of estimating the angle of the armpit from the acquired image for each frame from each of the human pose estimation algorithms a, b, and c, thereby obtaining a graph as illustrated in FIG. 3B. In FIG. 3B, the human pose estimation algorithm with the smallest change in the angle of the armpit depending on the rotation angle is the human pose estimation algorithm a, and thus the human pose estimation algorithm with the highest reliability is the human pose estimation algorithm a.

The processor 130 may acquire an image (hereinafter, “second image”) obtained by capturing an image of a person rotating while repeating a preset specific motion at a preset cycle with a single camera, estimate human body information (hereinafter, “second body information”) from the second image using the target human pose estimation algorithm for each frame, and evaluate the reliability of the target human pose estimation algorithm based on the second body information estimated for each frame.

As illustrated in FIG. 4, the preset specific motion may be a motion of raising and lowering one arm while straightening the arm but is not limited thereto. Various poses in which the change in the angle occurs in a specific body part of a person may be used as a specific motion. The specific motion may be repeated two or more times while a person rotates 360°.

The second body information may include information on the angle of the preset specific body part. The preset specific body part may also be a joint part whose angle may be confirmed from a captured image of a person, such as an armpit, an elbow, or a knee.

When a person rotates while repeating a specific motion at a predetermined cycle, an angle of a body part (joint part) associated with the corresponding motion changes in the form in which a predetermined pattern repeats regardless of the rotation angle. Therefore, the angle of the body part estimated through the human pose estimation algorithm should also change in the form in which the predetermined pattern repeats regardless of the rotation angle (or capturing direction). According to the present embodiment, by confirming whether the angle of the specific body part estimated for each frame of the image obtained by capturing an image of a person rotating 360° in a specific pose remains constant, it is possible to evaluate the reliability of the human pose estimation algorithm used for the corresponding estimation.

When evaluating the reliability of the target human pose estimation algorithm based on the second body information estimated for each frame, the processor may divide the second body information estimated for each frame into multiple groups and calculate a second indicator indicating similarity of change patterns of the second body information for each of the multiple groups.

The change patterns of the second body information may refer to information indicating how the second body information changes over a set cycle. The second indicator may be an indicator indicating how similar the change patterns of the second body information are for each group.

For example, the second indicator may be a value obtained by summing the similarities between different change patterns of the second body information. For example, when it is assumed that there are four groups, the second indicator may be calculated by summing a similarity between a first group and a second group, a similarity between the first group and a third group, a similarity between the first group and a fourth group, a similarity between the second group and the third group, a similarity between the second group and the third group, and a similarity between the third group and the fourth group. However, the method of calculating a second indicator is not limited to the above-described embodiment, and the second indicator may be calculated in various ways.

The processor 130 may divide the second body information estimated for each frame according to the set cycle (the cycle in which the specific motion repeats). For example, when it is assumed that a person performs a specific motion once for each 90° rotation, the processor 130 may group the second body information estimated from frames corresponding to images captured from a rotation angle of 0° to 90° into a first group, group the second body information estimated from frames corresponding to images captured from a rotation angle of 90° to 180° into a second group, group the second body information estimated from frames corresponding to images captured from a rotation angle of 180° to 270° into a third group, and group the second body information estimated from frames corresponding to images captured from a rotation angle of 270° to 360° into a fourth group.

For example, the processor 130 may acquire an image of a person rotating 360° while repeatedly raising and lowering one straightened arm and perform an operation of estimating an angle of an armpit (an angle between a body and an arm) from the acquired image for each frame from each of the human pose estimation algorithms a and b, thereby obtaining graphs as illustrated in FIGS. 5A and 5B. FIG. 5A illustrates the result of estimating the angle of the armpit using the human pose estimation algorithm a, and FIG. 5B illustrates the result of estimating the angle of the armpit using the human pose estimation algorithm b. Compared to FIG. 5B, it may be confirmed that the change patterns in the angle of the armpit for each group in FIG. 5A remain constant, and thus the human pose estimation algorithm with high reliability is the human pose estimation algorithm a.

In various embodiments, the processor 130 may calculate first indicators for each of a plurality of body parts and calculate a final first indicator from the calculated first indicators. In various embodiments, the processor 130 may also calculate a third indicator based on the first and second indicators. For example, the processor 130 may calculate the third indicator by summing a value obtained by multiplying the first indicator by a preset first weight and a value obtained by multiplying the second indicator by a preset second weight.

Meanwhile, although the above-described embodiment discloses that the first indicator may be calculated from an image obtained by capturing an image of a person rotating in a preset specific pose with a single camera, and the second indicator may be calculated from an image obtained by capturing an image of a person rotating while repeating a preset specific motion at a preset cycle with the single camera, the processor 130 may simultaneously calculate the first and second indicators using the image obtained by capturing an image of the person rotating while repeating the preset specific motion at the preset cycle with the single camera, with one part of the body fixed and another part moving. For example, the processor 130 may simultaneously calculate the first and second indicators using the image obtained by capturing an image of a person rotating while repeatedly raising and lowering one arm straight up and down, with the other arm extended straight forward. In this case, the processor 130 may calculate the first indicator from an image of a fixed arm and the second indicator from an image of a moving arm.

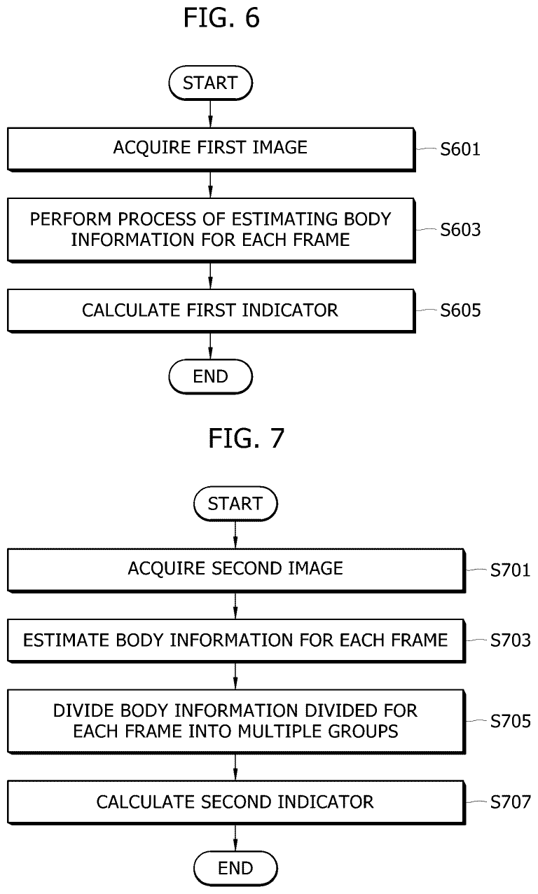

FIG. 6 is a first flowchart illustrating a method of evaluating reliability of a human pose estimation algorithm according to an embodiment of the present invention.

Hereinafter, referring to FIG. 6, the process of calculating the first indicator in the method of evaluating reliability of a human pose estimation algorithm will be described focusing on the operation of the processor 130. Some of the processes to be described below may be performed in a different order from the order to be described below or may be omitted.

First, the processor 130 may acquire a first image, obtained by capturing an image of a person rotating in a preset specific pose with a single camera, through the communication interface 110 (S601). For example, the preset specific pose may be a pose in which one arm is straightened upward and the other arm is straightened forward, but is not limited thereto. The rotation of the person may be performed by the corresponding person or by a rotation device such as a turntable.

Next, the processor 130 may estimate the human body information from the first image using the target human pose estimation algorithm for each frame (S603). The target human pose estimation algorithm is a human pose estimation algorithm whose reliability is to be evaluated and may be a human pose estimation algorithm that estimates a 3D pose of a person based on a monocular image. The first body information may include information on the length or angle of the preset specific body part. The preset specific body part may be a body part whose length may be confirmed from a captured image of a person, such as an upper arm, forearm, calf, or thigh of a person. The preset specific body part may also be a joint part whose angle may be confirmed from a captured image of a person, such as an armpit, elbow, or knee.

Next, the processor 130 may generate the first indicator indicating the consistency of the body information estimated for each frame (S605). The first indicator may be an indicator indicating how consistent the first body information estimated for each frame using the target human pose estimation algorithm remains. The processor 130 may calculate the first indicator from the above Equation 1.

FIG. 7 is a second flowchart illustrating the method of evaluating reliability of a human pose estimation algorithm according to an embodiment of the present invention.

Hereinafter, referring to FIG. 7, the process of calculating the second indicator in the method of evaluating reliability of a human pose estimation algorithm will be described focusing on the operation of the processor 130. Some of the processes to be described below may be performed in a different order from the order to be described below or may be omitted.

First, the processor 130 may acquire the second image, obtained by capturing an image of the person rotating in the preset specific pose with the single camera, through the communication interface 110 (S701). The preset specific motion may be a motion of raising and lowering one arm while straightening the arm, but is not limited thereto. The specific motion may be repeated two or more times while a person rotates 360°.

Next, the processor 130 may estimate the human body information from the second image using the target human pose estimation algorithm for each frame (S703). The body information may include information on the angle of the preset specific body part. The preset specific body part may also be a joint part whose angle may be confirmed from a captured image of a person, such as an armpit, elbow, or knee.

Next, the processor 130 may divide the estimated body information for each frame into multiple groups (S705). The processor 130 may divide the second body information estimated for each frame according to the set cycle (the cycle in which the specific motion repeats).

Next, the processor 130 may generate the second indicator indicating the similarity of the change patterns of the body information for each of the multiple groups (S707). The change patterns of the body information may refer to information indicating how body information changes over a set period. The second indicator may be an indicator indicating how similar the change patterns of the body information are for each group. For example, the processor 130 may calculate the value obtained by summing the similarities between different change patterns of the body information as the second indicator.

As described above, according to the present invention, it is possible to evaluate the reliability of a human pose estimation algorithm capable of estimating a human 3D pose based on a monocular image without a separate ground truth.

According to one aspect of the present invention, it is possible to evaluate the reliability of a human pose estimation algorithm capable of estimating a human 3D pose based on a monocular image without a separate ground truth.

Although the present invention has been described with reference to embodiments shown in the accompanying drawings, they are only examples. It will be understood by those skilled in the art that various modifications and other equivalent exemplary embodiments are possible for the present invention. Accordingly, the technical scope of the present invention is to be determined from the spirit of the appended claims.

What is claimed is:

1. An apparatus for evaluating reliability of a human pose estimation algorithm for estimating a human three-dimensional (3D) pose based on a monocular image, comprising:
a memory configured to store at least one instruction; and
a processor configured to execute the at least one instruction stored in the memory,
wherein the processor acquires a first image obtained by capturing an image of a person rotating in a preset specific pose with a single camera, estimates first body information of the person from the first image using a target human pose estimation algorithm for each frame, and evaluates reliability of the target human pose estimation algorithm based on the first body information estimated for each frame.

2. The apparatus of claim 1, wherein the first body information includes a length or angle of a preset specific body part.

3. The apparatus of claim 1, wherein, when evaluating the reliability of the target human pose estimation algorithm based on the first body information estimated for each frame, the processor calculates a first indicator indicating consistency of the first body information estimated for each frame.

4. The apparatus of claim 3, wherein the first indicator is calculated from the following Equation 1,
$$Consistency ( x ) = \frac{{\sum }_{i = 1}^{N} \vert {x}_{i} - σ \vert}{{α}_{scale} \times N} , where σ = \frac{M + m}{2} \qquad [ Equation 1 ]$$
(here, consistency is the first indicator, xᵢ is human body information estimated from an ith frame, α_{scale} is a scaling factor, N is a total number of frames, M is a maximum value of the human body information estimated for each frame, and m is a minimum value of the human body information estimated for each frame).

5. The apparatus of claim 1, wherein the processor acquires a second image obtained by capturing an image of a person rotating while repeating a preset specific motion at a preset cycle with the single camera, estimates second body information of the person from the second image using the target human pose estimation algorithm for each frame, and evaluates the reliability of the target human pose estimation algorithm based on the second body information estimated for each frame.

6. The apparatus of claim 5, wherein the specific motion is repeated two or more times while the person rotates 360°.

7. The apparatus of claim 5, wherein the second body information includes an angle of a preset specific body part.

8. The apparatus of claim 5, wherein, when evaluating the reliability of the target human pose estimation algorithm based on the second body information estimated for each frame, the processor divides the second body information estimated for each frame into multiple groups and calculates a second indicator indicating similarity of change patterns of the second body information for each group.

9. The apparatus of claim 8, wherein the processor divides the second body information estimated for each frame according to the preset cycle.

10. An apparatus for evaluating reliability of a human pose estimation algorithm for estimating a human three-dimensional (3D) pose based on a monocular image, comprising:
a memory configured to store at least one instruction; and
a processor configured to execute the at least one instruction stored in the memory,
wherein the processor acquires an image obtained by capturing an image of a person rotating while repeating a preset specific motion at a preset cycle with a single camera, estimates the human body information from the image using the target human pose estimation algorithm for each frame, and evaluates the reliability of the target human pose estimation algorithm based on the body information estimated for each frame.

11. The apparatus of claim 10, wherein, when evaluating the reliability of the target human pose estimation algorithm based on the body information estimated for each frame, the processor divides the body information estimated for each frame into multiple groups and calculates a second indicator indicating similarity of change patterns of the body information for each group.

12. A method of evaluating reliability of a human pose estimation algorithm for estimating a human three-dimensional (3D) pose based on a monocular image, which is performed on a computing device including a processor, the method comprising:
acquiring a first image obtained by capturing an image of a person rotating in a preset specific pose with a single camera;
performing a process of estimating first body information of the person from the first image using a target human pose estimation algorithm for each frame; and
evaluating reliability of the target human pose estimation algorithm based on the first body information estimated for each frame.

13. The method of claim 12, wherein the first body information includes a length or angle of a preset specific body part.

14. The method of claim 12, wherein, in the evaluating of the reliability of the target human pose estimation algorithm based on the first body information estimated for each frame, a first indicator indicating consistency of the first body information estimated for each frame is calculated.

15. The method of claim 14, wherein the first indicator is calculated from the following Equation 1,
$$Consistency ( x ) = \frac{{\sum }_{i = 1}^{N} \vert {x}_{i} - σ \vert}{{α}_{scale} \times N} , where σ = \frac{M + m}{2} \qquad [ Equation 1 ]$$
(here, consistency is the first indicator, xᵢ is human body information estimated from an ith frame, α_{scale} is a scaling factor, N is a total number of frames, M is a maximum value of the human body information estimated for each frame, and m is a minimum value of the human body information estimated for each frame).

16. The method of claim 12, further comprising:
acquiring a second image obtained by capturing an image of a person rotating while repeating a preset specific motion at a preset cycle with a single camera;
performing a process of estimating first body information of the person from the first image using a target human pose estimation algorithm for each frame; and
evaluating the reliability of the target human pose estimation algorithm based on the second body information estimated for each frame.

17. The method of claim 16, wherein the specific motion is repeated two or more times while the person rotates 360°.

18. The method of claim 16, wherein the second body information includes an angle of a preset specific body part.

19. The method of claim 16, wherein, in the evaluating of the reliability of the target human pose estimation algorithm based on the second body information estimated for each frame, the second body information estimated for each frame is divided into multiple groups and a second indicator indicating similarity of change patterns of the second body information for each group is calculated.

20. The method of claim 19, wherein, in the evaluating of the reliability of the target human pose estimation algorithm based on the second body information estimated for each frame, the second body information estimated for each frame is divided according to the preset cycle.
